(19) United States
(12) Patent Application Publication
(10) Pub. No.: US 2026/0292674 A1
(43) Pub. Date: Sep. 24, 2026

(54) SECONDARY CELL GROUP (SCG) SECURITY KEY UPDATE FOR SELECTIVE SCG ACTIVATION IN WIRELESS SYSTEMS

(71) Applicant: Apple Inc., Cupertino, CA (US)

(72) Inventors: Fangli XU, Beijing (CN); Shu GUO, Beijing (CN); Naveen Kumar R. PALLE VENKATA, San Diego, CA (US); Haijing HU, Cupertino, CA (US); Yuqin CHEN, Beijing (CN)

(73) Assignee: Apple Inc., Cupertino, CA (US)

(21) Appl. No.: 19/472,560

(22) PCT Filed: Apr. 4, 2023
(86) PCT No.: PCT/CN2023/086220

§ 371 Date: Oct. 3, 2025

(51) Int. Cl. H04W 48/20; H04W 12/041; H04W 12/0431; H04W 76/20; H04W 80/02

(52) U.S. Cl. CPC H04W 48/20; H04W 12/041; H04W 12/0431; H04W 76/20; H04W 80/02

(57) ABSTRACT

Some aspects relate to apparatuses and methods to update secondary cell group (SCG) security key. A user equipment (UE) can receive a master node configuration from a master node (MN), where the master node configuration can include an ordered list of counter numbers, and a list of candidate SCGs. The UE can maintain an activation record including a total number of SCG activations. The UE can select a candidate SCG to be activated to become an active SCG served by an active secondary node based on a determination that an activation condition for the candidate SCG is met. The UE can select a counter number from the ordered list of counter numbers determined based on the total number of SCG activations and a predetermined selection rule applicable by the UE and the MN. The UE can generate a security key for the active SCG based on the selected counter number.

### BACKGROUND

### Field

The described aspects generally relate to wireless communication, including secondary cell group (SCG) security key update for selective SCG activation in wireless systems.

### Related Art

In a wireless system, dual connectivity (DC) has been used to increase data throughput at a user equipment (UE). In a wireless system with DC, the UE can transmit and receive data on multiple component carriers from two or more cell groups, such as a master cell group (MSG), and second cell groups (SCGs), to increase the throughput of the UE. In the fifth generation (5G) new radio (NR) standard developed by the 3rd Generation Partnership Project (3GPP), dual connectivity to a UE can be provided by a first base station serving in a primary cell (PCell) and a second base station serving in a secondary cell (SCell). New Radio Dual Connectivity (NR DC) allows a UE to be connected to two serving nodes having multiple carriers in each node using the carrier aggregation technique. However, it is desired to improve the security for a UE with dual connectivity having multiple SCGs.

### SUMMARY

Some aspects of this disclosure relate to apparatuses and methods for implementing mechanisms to update secondary cell group (SCG) security key for selective SCG activation in wireless systems supporting dual connectivity (DC). A candidate SCG for a user equipment (UE) can be selectively activated among a list of candidate SCGs when an activation condition for the candidate SCG is met. Embodiments herein can be applicable to the fifth generation (5G) new radio (NR) wireless networks, systems developed based on the 3rd Generation Partnership Project (3GPP) standards, or other wireless systems.

Some aspects of this disclosure relate to a UE. The UE can include a transceiver, and a processor communicatively coupled to the transceiver. The transceiver can be configured to enable communication in a wireless system, where the wireless system includes a master node (MN) of a primary cell (PCell) and a plurality of secondary nodes (SNs) of a plurality of second cell groups (SCGs). According to some aspects, the processor of the UE can receive a master node configuration from the MN, where the master node configuration can include an ordered list of counter numbers, and a list of candidate SCG configurations of the plurality of SCGs served by a list of candidate SNs. A counter number of the ordered list of counter numbers can be allocated to any candidate SCG of the list of candidate SCGs. A candidate SCG served by a candidate SN has an associated activation condition. Once the associated activation condition is met, the candidate SCG can be activated to become an active SCG, and the candidate SN becomes an active SN. In some embodiments, the ordered list of counter numbers can include a block of consecutive numbers in a range defined by a starting number and a maximum number indicated by the master node configuration.

According to some aspects, the processor of the UE can maintain an activation record including a total number of SCG activations by the UE before selecting the candidate SCG to be activated, where the total number of SCG activations has an initial value. The processor can further select the candidate SCG and the candidate SN to be activated to become an active SCG served by an active SN based on a determination that the associated activation condition for the candidate SCG is met. Afterwards, the processor can update the total number of SCG activations to increase the initial value by 1 to be a current value of the total number of SCG activations based on the activation of the candidate SCG.

According to some aspects, the processor of the UE can select a counter number from the ordered list of counter numbers, where the counter number has an index within the ordered list. The index can be determined based on the current value of the total number of SCG activations and a predetermined selection rule applicable by the UE and the MN. The processor can further generate a security key for the active SCG served by the active SN based on the selected counter number and a security key of the MN. The processor can further communicate data between the UE and the active SN within the active SCG, where the data is securely protected by the security key for communication between the UE and the active SN.

Some aspects of this disclosure relate to a base station. The base station can include a transceiver, and a processor communicatively coupled to the transceiver. The transceiver can be configured to enable communication in a wireless system, where the wireless system includes the base station as a MN of a MCG, a UE, and a plurality of SNs of a plurality of SCGs.

According to some aspects, the processor of the base station can transmit a master node configuration to the UE. The master node configuration can include an ordered list of counter numbers, and a list of candidate SCGs of the plurality of SCGs served by a list of candidate SNs. A candidate SCG served by a candidate SN has an associated activation condition. Once the associated activation condition is met, the candidate SCG can be activated to become an active SCG, and the candidate SN becomes an active SN. A counter number of the ordered list of counter numbers is able to be allocated to any candidate SCG of the list of candidate SCGs.

According to some aspects, the processor of the base station can identify a security key for an active SCG served by an active SN after a completion of an activation of the candidate SCG and the candidate SN to become the active SCG served by the active SN based on a determination that the associated activation condition for the candidate SCG is met. The security key for the active SCG can be generated based on a security key of the MN, an activation record of the list of candidate SNs including a total number of SCG activations by the UE, and a counter number selected from the ordered list of counter numbers based on the total number of SCG activations and a predetermined selection rule applicable by the UE and the MN. The total number of SCG activations refers to the current value of the total number of SCG activations that includes the activation of the candidate SCG and the candidate SN.

This summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIGS. 1A-1C illustrate a wireless system to support secondary cell group (SCG) security key update for selective SCG activation, according to some aspects of the disclosure.

FIG. 2 illustrates a block diagram of a UE or a base station to perform functions described herein, according to some aspects of the disclosure.

FIGS. 3A-3B illustrate example processes performed by a UE or a base station to support SCG security key update for selective SCG activation, according to some aspects of the disclosure.

FIGS. 4A-4D illustrate example processes for SCG security key update for selective SCG activation, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In a wireless system supporting dual connectivity (DC), a user equipment (UE) can transmit and receive data on multiple component carriers (CC) from at least two cell groups, master cell group (MCG) including a master node (MN) in a primary cell (PCell), and secondary cell (SCell) groups (SCGs) including secondary nodes (SNs), to increase the throughput of the UE. An MN and/or an SN may be a base station. A SCG can include a primary secondary cell (PScell) and other secondary cells. In some embodiments, dual connectivity can be used to aggregate long-term evolution (LTE) and 5G new radio (NR) in E-UTRA-NR (EN-DC) technology. In 5G NR DC, two or more base stations, such as g-NodeB (gNB) of the 5G wireless network, may configure a PCell using PCell CC (PCC) and one or more CCs of SCell (SCC) for communication between the UE and the 5G wireless network using dual connectivity. In the present disclosure, various embodiments are related to handling security key update during a conditional PSCell change (CPC) procedure among multiple SCGs in a connected state of a UE. Currently, during each PSCell change in the connected state of the UE, security keys are exchanged with the UE using level-3 signaling, for example, RRC signaling. In other words, the UE is reconfigured for security keys each time there is a PSCell change or SCG change. Various embodiments described herein eliminate a need for reconfiguring the UE for a secure connection with one or more PSCells or their corresponding SNs in the one or more SCGs, during the CPC procedure.

In 3GPP Technical Specification (TS) 37.340 Release 17, a conditional PSCell addition (CPA) procedure was introduced, and according to which a network may configure multiple candidate secondary cell groups (SCGs) for a UE for an SCG addition. For each candidate SCG, a network and/or a master node (MN) may also provide one or more radio conditions or activation conditions that need to be met for connecting to the candidate SCG. As the UE performs evaluation of the one or more radio conditions for the candidate SCG, the UE may add the candidate SCG upon fulfillment of the one or more radio conditions configured by the network and/or the MN. Once the candidate SCG is added by the UE, the UE releases a configuration related to all other candidate SCGs. Accordingly, the CPC/CPA configurations are released after PCell change. Therefore, reconfiguration of the UE is needed for a subsequent CPA mechanism for the UE to add another SCG or CPC mechanism for the UE to switch to another SCG. Accordingly, procedures in TS 37.340 Release 17 has some inefficiency.

According to some aspects, the UE may perform an intra-SN CPC mechanism, an inter-SN CPC mechanism, and/or an MN/SN initiated CPC mechanism, as described in TS 37.340 Release 17, and according to which the UE may perform an evaluation of one or more radio conditions for an intra-SN CPC mechanism, an inter-SN CPC mechanism, and/or an MN/SN initiated CPC mechanism. Upon fulfillment of the one or more conditions corresponding to the intra-SN CPC mechanism, the inter-SN CPC mechanism, and/or the MN/SN initiated CPC mechanism, and upon completion of the intra-SN CPC mechanism, the inter-SN CPC mechanism, and/or the MN/SN initiated CPC mechanism, the UE may release a configuration related to SCGs to which the UE is not currently connected. Accordingly, reconfiguration of the UE is needed for a subsequent intra-SN CPC mechanism, inter-SN CPC mechanism, and/or MN/SN initiated CPC mechanism.

In some embodiments, to improve efficiency, a baseline procedure to support SCG change can include the following steps: (1) Step 1: when the execution condition of a CPC candidate PSCell is met, the UE performs the execution of CPC towards this candidate PScell; (2) Step 2: after finishing the PSCell addition or change, the UE doesn't release the conditional configuration of the other candidate PSCells for subsequent CPC, the UE continues evaluating the execution conditions of other candidate PScells; (3) Step 3: When the execution condition of a candidate PScell is met, the UE performs the execution of CPC towards this candidate PSCell. Such a process of adding or changing to the candidate PScell and its corresponding SCG upon fulfillment of the one or more radio conditions may be referred to as selective activation of the candidate SCG.

For a secure connection with a primary cell (PCell), the MN may provide the UE with a security configuration to derive a security key corresponding to a base station or an MN (Kg_{NB}). The MN may also provide the UE with a counter number, such as a parameter sk_counter to be used by the candidate SN as part of an SN addition procedure and/or an SN change procedure. In some embodiments, the MN may send a particular sk_counter to the candidate SN to be used to generate the security key for the candidate SN, where the particular sk_counter is not shared by other SNs. In some other embodiments, the MN can provide a master node configuration that includes a list of counter numbers, e.g., a list of sk_counters, and a list of candidate SCGs served by a list of candidate SNs. A counter number of the list of counter numbers can be allocated to any candidate SCG of the list of candidate SCGs. Accordingly, a counter number is not specifically allocated to any particular SN, but shared among all the candidate SNs for the list of candidate SCGs. Hence, the list of counter numbers shared by the list of candidate SCGs can provide more flexibility. In some embodiments, the list of counter numbers can be an ordered list so that a counter number in the list has an index. The ordered list of counter numbers can further improve the security and reduce the need to communicate the security key explicitly between the UE and the SN. Instead, an index of the counter numbers within the ordered list can be communicated. A counter number can refer to an integer or a number that is used for security key generation. A counter number may be a number generated by a counter. In the current description, the term “counter number” may be used interchangeably with the term sk_counter, since a sk_counter can be an example of a counter number.

In some embodiments, the UE may use the Kg_{NB} and sk_counter to derive a security key for the SN, K_{SN}, in order to further derive a cipher key (CK) and an integrity key (IK) for a secure bearer connection, e.g., a data radio bearer (DRB) connection, or a signaling radio bearer (SRB), which terminates at an SN packet data convergence protocol (PDCP) layer. The MN also derives a K_{SN} using the Kg_{NB} and a respective sk_counter and provides the derived K_{SN} to each respective SN (or PSCell). The SN uses received K_{SN} to derive a CK and an IK for the secure bearer connection with the UE. The security configuration may be also referred to as a CPC configuration.

In a legacy cell group (CG) change mechanism, the UE is mandated to release a configuration, including a security configuration, related to a source CG upon completion of the CG change mechanism. Accordingly, the UE is mandated to release the sk_counter after applying it, and the MN needs to provide a new sk_counter to the UE, and a new K_{SN} to each candidate PSCell or SN each time whenever there is a change in an SN (or PSCell).

In some embodiments, to avoid the reconfiguration of the UE each time whenever there is a change in an SN (or PSCell), the UE may be configured to save the previous configuration corresponding to each SCG. However, in such a way, the UE may end up reusing the same K_{SN} when the UE returns back to the same SN (or PSCell), which may pose a security risk.

Various embodiments described in the present disclosure provide solutions eliminating a need to reconfigure the UE with a security configuration each time whenever there is a change in an SN (or PSCell), and also assuring that a new K_{SN} is used by the UE when the UE returns back to the same SN (or PSCell) to which the UE may be once connected earlier. In addition, an ordered list of counter numbers can be used, where a counter number of the ordered list can be allocated to any candidate SCG of the list of candidate SCGs. Accordingly, a counter number is not specifically allocated to any particular SN, but shared among all the candidate SNs for the list of candidate SCGs. Hence, the list of counter numbers shared by the list of candidate SCGs can provide more flexibility and more security.

Accordingly, no RRC reconfiguration is performed for security key change per SCG change (CPC/CPA) during the selective SCG activation procedure. In addition, same SCG key may not be reused if the activated SCG is changed. The network or MN can configure a sk_counter pool in a master node configuration, and the resource in the sk_counter pool can be used on any candidate SCG configuration. A sk_counter pool may be referred to as an ordered list of count numbers, where each sk_counter is a number is generated by a counter. Accordingly, a sk_counter resource is not allocated per SCG, but across all candidate SCGs. For each SCG change/activation, MN and the UE follow the same rule to select one sk_counter from the sk_counter pool to generate a SCG security key for the newly activated SCG. In addition, the MN can share the SCG key list which all candidate SCGs through a network interface, and the order of SCG key in the SCG key list is the same as that of sk_counter in the sk_counter pool.

In some embodiments, for each SCG activation or UE access to candidate SCG, the MN and candidate SN can exchange the SCG security key usage. If the UE sends SCG RRCRecfgComplete message to the SN directly, the SN will inform the MN, and the MN updates the SCG key list amongst all candidate SNs. If the UE sends a SCG RRCRecfgComplete message to the MN, the MN will inform the selected SN and updates SCG key list amongst all candidate SNs.

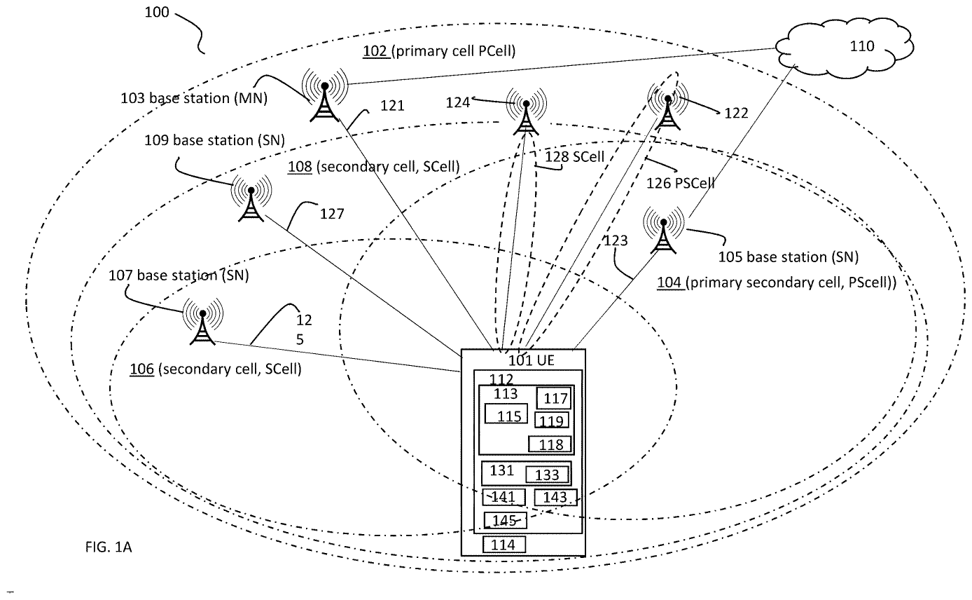

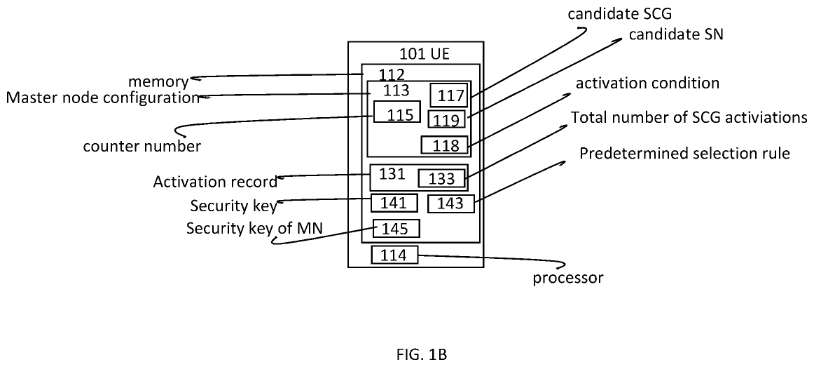

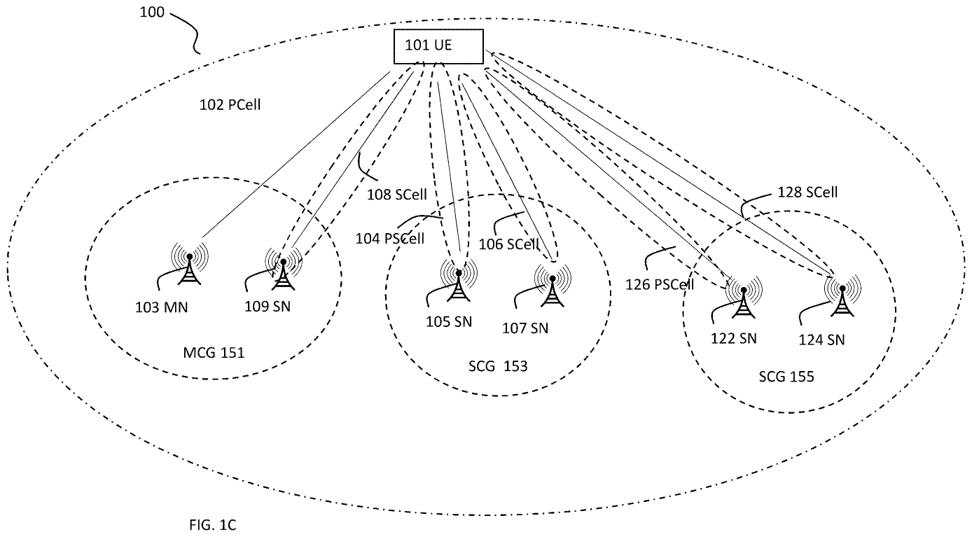

FIGS. 1A-1C illustrate a wireless system 100 including a UE, e.g., UE 101, configured to support SCG security key update for selective SCG activation, according to some aspects of the disclosure. FIG. 1A provides wireless system 100 for the purpose of illustration, where wireless system 100 can include, but is not limited to, UE 101, a base station 103, a base station 105, a base station 107, a base station 109, a base station 122, and a base station 124, all communicatively coupled to a core network 110. UE 101 communicates with base station 103 over a communication link 121, communicates with base station 105 over a communication link 123, communicates with base station 107 over a communication link 125, communicates with base station 109 over a communication link 127, and over other communication links with other base stations.

In some examples, wireless system 100 can be a non-standalone (NSA) system that includes one or more of a NR system, a LTE system, a 5G system, or some other wireless system. In some examples, wireless system 100 can be a standalone (SA) system including a NR system. There can be other network entities, e.g., network controller, a relay station, not shown. Wireless system 100 can support a wide range of use cases such as enhanced mobile broad band (eMBB), massive machine type communications (mMTC), ultra-reliable and low-latency communications (URLLC), and enhanced vehicle to anything communications (eV2X).

According to some aspects, base station 103, base station 105, base station 107, base station 109, base station 122, base station 124 can be a fixed station or a mobile station. Base station 103, base station 105, base station 107, base station 109, base station 122, base station 124 can also be called other names, such as a base transceiver system (BTS), an access point (AP), a transmission/reception point (TRP), an evolved NodeB (eNB), a next generation node B (gNB), a 5G node B (NB), or some other equivalent terminology. In some examples, base station 103 can be a gNB, while base station 105 and base station 107 can be a gNB or an eNB. In some examples, base station 103, base station 105, base station 107, base station 109, base station 122, base station 124 can be interconnected to one another and/or to other base station or network nodes in a network through various types of backhaul interfaces such as a direct physical connection, a virtual network, and/or the like, not shown.

According to some aspects, UE 101 can be stationary or mobile. UE 101 can be a cellular phone (e.g., a smart phone), a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

According to some aspects, base station 103, base station 105, base station 107, base station 109, base station 122, base station 124 can be communicatively coupled to core network 110. Base station 103 can serve a cell 102, base station 105 can serve a cell 104 contained within cell 102, base station 107 can serve a cell 106 contained within cell 102 that overlaps with cell 104, base station 109 can serve a cell 108 contained within cell 102 that overlaps with cell 104, base station 122 can serve a cell 126 contained within cell 102, and base station 124 can serve a cell 128 contained within cell 102.

In some other embodiments, cell 102 can overlap with cell 104, cell 106, cell 108, cell 126, and cell 128. Cell 102, cell 104, cell 106, cell 108, cell 126, and cell 128 can be a macro cell, a pico cell, a femto cell, and/or another type of cell. In comparison, a macro cell can cover a relatively large geographic area, e.g., several kilometers in radius, a femto cell can cover a relatively small geographic area, e.g., a home, while a pico cell covers an area smaller than the area covered by a macro cell but larger than the area covered by a femto cell. For example, cell 102 can be a macro cell, while cell 104 and cell 106 can be a pico cell or a femto cell. In addition, cell 102 can be a pico cell while cell 104 and cell 106 can be a femto cell. In some examples, the geographic area of a cell can move according to the location of a mobile base station.

According to some aspects, base station 103 can be the serving base station, a primary node, or a master node (MN), and cell 102 can be the serving cell or primary cell (PCell). Hence, base station 103 can be referred to as MN 103. Base station 105, base station 107, base station 109, base station 122, base station 124 can be neighbor base stations to UE 101 and can be secondary nodes (SNs). Cell 104, cell 106, cell 108, cell 126, and cell 128 can be secondary cells (SCell), or primary secondary cells (PScells). There can be other secondary cells for UE 101, not shown. Data for UE 101 can be simultaneously transferred between UE 101 and core network 110 by one or more component carriers between UE 101 and base station 103 on communication link 121, one or more component carriers between UE 101 and base station 105 on communication link 123, and one or more component carriers between UE 101 and base station 107 on communication link 125, or other links, not shown. UE 101 can communicate with the serving base station, e.g., base station 103, using a first frequency band, and communicate with a neighbor base station, e.g., base station 105 or base station 107 using a second frequency band different from the first frequency band. In some embodiments, cell 102, which is the PCell, may be referred to as the anchor cell that provides a radio resource control (RRC) connection to the UE 101. In some examples, the PCell (cell 102) and the SCell, e.g., cell 104, may be co-located (e.g., different TRPs at the same physical location).

In some embodiments, one or more of the SCells, such as cell 104 or cell 106, may be activated or added to cell 102, which is the PCell, to form the serving cells serving the UE 101. Each serving cell utilizes one or more CCs. The CC of the PCell, e.g., cell 102, may be referred to as a primary CC (PCC), and the CC of a SCell, e.g., cell 104 or cell 106, may be referred to as a secondary CC (SCC). Each one of the PCell (cell 102) and one or more of the SCells (cell 104, cell 106, cell 108, cell 126, or cell 128) may be served by a respective base station 103, base station 105, base station 107, base station 109, base station 122, or base station 124. The coverages of the PCell and SCell may differ since component carriers in different frequency bands may experience different path loss. In some embodiments, the PCell (cell 102) may add or remove one or more of the SCells (cell 104, cell 106, cell 108, cell 126, or cell 128) to improve reliability of the connection to the UE 101 and/or increase the data rate.

In some embodiments, the PCell (cell 102) may be a low band cell using a low frequency band, and the SCells (cell 104, cell 106, cell 108, cell 126, or cell 128) may be high band cells using a high frequency band. A low band (LB) cell uses a CC in a first frequency band, such as a first frequency range (FR1) that is lower than that of the high band cells using a second frequency band. Accordingly, the first frequency band can be in the first frequency range (FR1), and the second frequency band can be in the FR1, or the second frequency range (FR2). In some embodiments, the high band cells may use millimeter wave (mmW) CC, and the low band cell may use a CC in a band (e.g., sub-6 GHz band) lower than mmW. In general, a cell using a mmW CC can provide greater bandwidth than a cell using a low band CC. In addition, when using a frequency carrier that is above 6 GHz (e.g., mmW), beamforming may be used to transmit and receive signals in some examples. For example, the FR1 can be below 7.225 GHz and the FR2 frequency range can be in the mmWave frequency above 24.250 GHz. When communicating with the 5G network, the UE may be configured with one or more bandwidth parts (BWPs) of FR1 and/or FR2 on which to communicate.

In some embodiments, UE 101 may be served by base station 103, which can be the MN, and one or more secondary nodes, e.g., base station 105 and/or base station 107. A master cell group (MCG) is associated with the base station 103 in the PCell and one or more SCells (cell 108). In some embodiments, FIG. 1C illustrates multiple secondary cell groups (SCGs) associated with the SCells. For example, as shown in FIG. 1C, SCell 104 and SCell 106 may form a SCG 153, and SCell 126 and SCell 128 may form a SCG 155. Different SCGs may include a different number of SCells. A SCell in a SCG may be a PSCell. For example, cell 104 may be a PSCell in SCG 153, and cell 126 may be a PSCell in SCG 155. Each SCell may correspond to a base station. For example, cell 108 corresponds to SN 109, cell 104 corresponds to SN 105, cell 106 corresponds to SN 107, cell 126 corresponds to SN 122, and cell 128 corresponds to SN 124. Due to the one-to-one correspondence between a SCell and a SN, a SN and a SCell may be used interchangeably.

In some embodiments, the PCell, the PSCells used for serving the UE 101 may change over time. For example, due to traffic conditions at the MN (base station 103) or some other factor, the MN (base station 103) may elect to add another PSCell for serving UE 101. As another example, due to signaling conditions between the UE 101 and one or more of the current PSCells (e.g., as determined from signal measurements made by the UE 101), the MN (base station 103) or one of the PSCells may elect to change out one or more PSCells. A PSCell change may happen when a certain activation condition for a SCG is met. Such a process of adding or changing to the candidate PScell and its corresponding SCG upon fulfillment of the one or more radio conditions may be referred to as selective activation of the candidate SCG. UE 101, base station 103 that is a MN, and other SNs can perform various operations for updating SCG security key for selective SCG activation.

FIG. 1B illustrates more details of UE 101 related to operations performed to support secondary cell group (SCG) security key update for selective SCG activation. In some embodiments, as shown in FIGS. 1A-1B, UE 101 can include a transceiver, a memory 112, and a processor 114 communicatively coupled to the transceiver and memory 112. The transceiver can be configured to enable communication in wireless system 100.

According to some aspects, processor 114 can receive a master node configuration 113 from the MN 103, where the master node configuration 113 can include an ordered list of counter numbers, and a list of candidate SCGs configurations of the plurality of SCGs served by a list of candidate SNs. Master node configuration 113 can also be referred to as a MCG configuration. A counter number 115 of the ordered list of counter numbers can be allocated to any candidate SCG of the list of candidate SCGs. A candidate SCG 117 served by a candidate SN 119 has an associated activation condition 118. Once the associated activation condition 118 is met, the candidate SCG 117 can be activated to become an active SCG, and the candidate SN 119 becomes an active SN. In some embodiments, the ordered list of counter numbers can include a block of consecutive numbers in a range defined by a starting number and a maximum number indicated by the master node configuration.

According to some aspects, processor 114 can maintain an activation record 131 including a total number of SCG activations 133 by UE 101 before selecting the candidate SCG to be activated, where the total number of SCG activations 133 can have an initial value. The processor can further select the candidate SCG 117 and the candidate SN 119 to be activated to become an active SCG served by an active SN based on a determination that the associated activation condition 118 for the candidate SCG 117 is met. Afterwards, processor 114 can update the total number of SCG activations 133 to increase the initial value by 1 to be a current value of the total number of SCG activations based on the activation of the candidate SCG 117.

According to some aspects, processor 114 can select a counter number, e.g., counter number 115, from the ordered list of counter numbers, where the counter number has an index within the ordered list. The index can be determined based on the current value of the total number of SCG activations and a predetermined selection rule 143 applicable by UE 101 and MN 103. Processor 114 can further generate a security key 141 for the active SCG served by the active SN based on the selected counter number and a security key 145 of the MN. Processor 114 can further communicate data between UE 101 and the active SN within the active SCG, where the data is encrypted by the security key 141 for communication between the UE and the active SN.

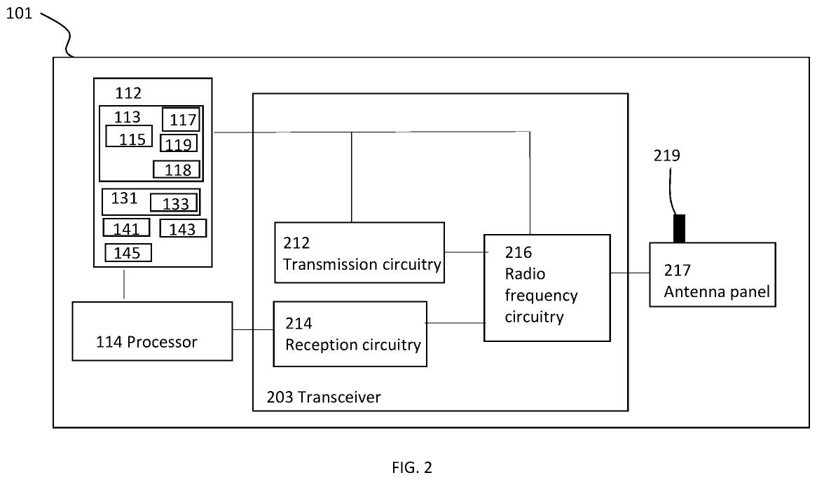

FIG. 2 illustrates a block diagram of UE 101, having antenna panel 217 including one or more antenna elements, e.g., an antenna element 219 coupled to transceiver 203 and controlled by processor 114. In detail, transceiver 203 can include radio frequency (RF) circuitry 216, baseband transmission circuitry 212, and baseband reception circuitry 214. RF circuitry 216 can include multiple parallel RF chains for one or more of transmit or receive functions, each connected to one or more antenna elements of the antenna panel. In addition, processor 114 can be communicatively coupled to memory 112, which is further coupled to transceiver 203. A base station, such as base station 103, can be implemented similarly as for UE 101 as shown to include a transceiver, a processor, a memory, and other components.

In some examples, RF circuitry 216 is used by UE 101 to update SCG security key for selective SCG activation in wireless systems. Memory 112 can store master node configuration 113, counter number 115, candidate SCG 117, candidate SN 119, associated activation condition 118, activation record 131, the total number of SCG activations 133, security key 141 for the active SCG served by the active SN, security key 145 of the MN, predetermined selection rule 143. Memory 112 can include instructions, that when executed by processor 114 perform the functions described herein. Alternatively, processor 114 can be “hard-coded” to perform the functions described herein.

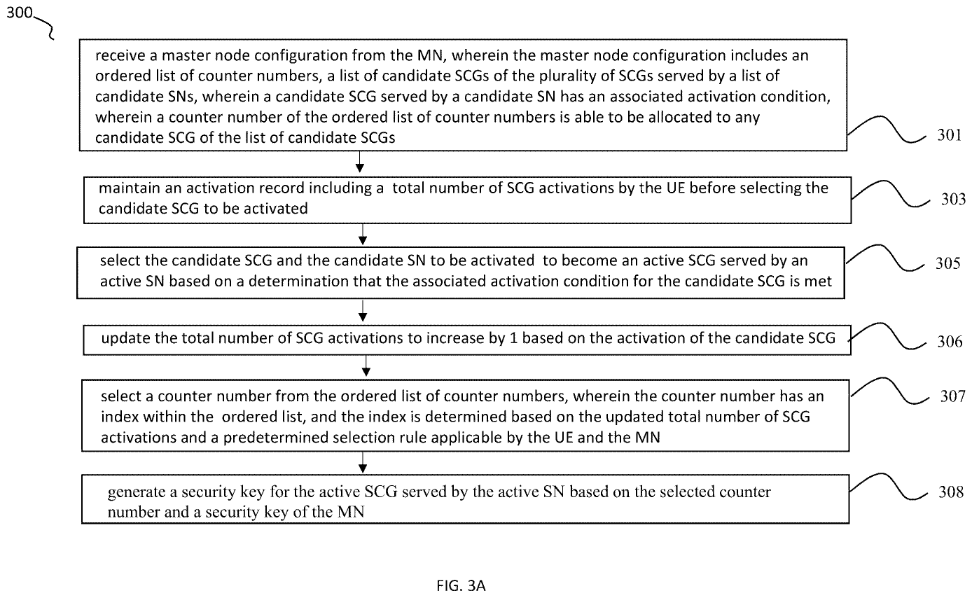

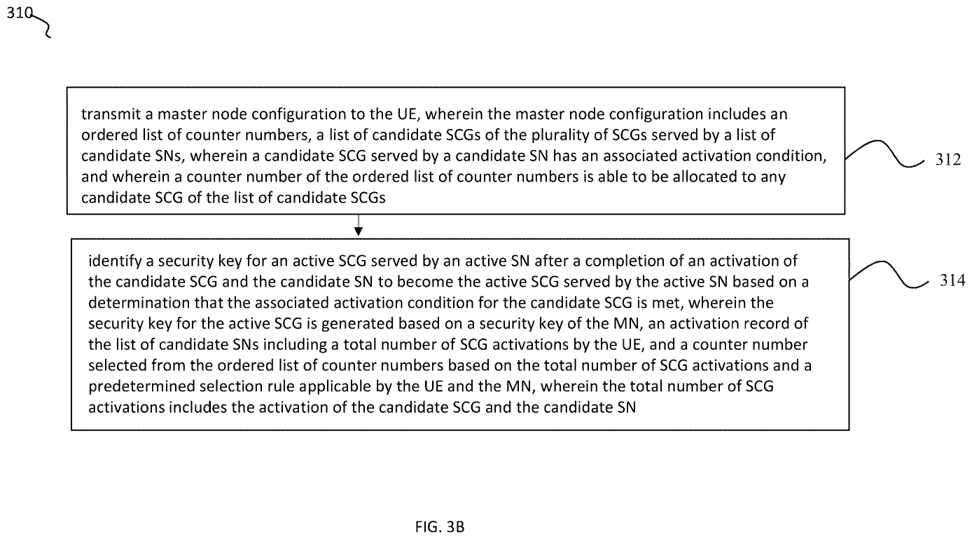

FIG. 3A illustrates an example process 300 performed by a UE to update SCG security key for selective SCG activation, according to some aspects of the disclosure. Process 300 can be performed by UE 101 as shown in FIGS. 1A-1C and FIG. 2, and process 310 can be performed by base station 103 as shown in FIGS. 1A-1C.

At 301, UE 101 can receive master node configuration 113 from MN 103. Master node configuration 113 can include an ordered list of counter numbers in MCG configuration, and a list of candidate SCG configurations of the plurality of SCGs served by a list of candidate SNs. A counter number 115 of the ordered list of counter numbers can be allocated to any candidate SCG of the list of candidate SCGs. Candidate SCG 117 served by candidate SN 119 has the associated activation condition 118. Once the associated activation condition 118 is met, candidate SCG 117 can be activated to become an active SCG, and candidate SN 119 becomes an active SN.

At 303, UE 101 can maintain activation record 131 including the total number of SCG activations 133 by the UE which has an initial value before selecting a candidate SCG to be activated.

At 305, UE 101 can select candidate SCG 117 and candidate SN 119 to be activated to become an active SCG served by an active SN based on a determination that the associated activation condition 118 for the candidate SCG 117 is met.

At 306, UE 101 can update the total number of SCG activations 133 to increase the initial value by 1 to be a current value of the total number of SCG activations, based on the activation of the candidate SCG 117.

At 307, UE 101 can select counter number 115 from the ordered list of counter numbers, where the counter number has an index within the ordered list. The index can be determined based on the current value of the total number of SCG activations and a predetermined selection rule 143 applicable by UE 101 and MN 103. Once, the index is known, the counter number (e.g., 115) follows.

At 308, UE 101 can generate the security key 141 for the active SCG served by the active SN based on the selected counter number 115 and the security key 145 of the MN. Accordingly, UE 101 can further communicate data with the active SN within the active SCG, where the data is encrypted by the security key 141 for communication between the UE and the active SN. Various techniques can be used to generate the security key 141 based on the selected counter number 115 and the security key 145 of the MN, such as techniques defined in the current communication standards.

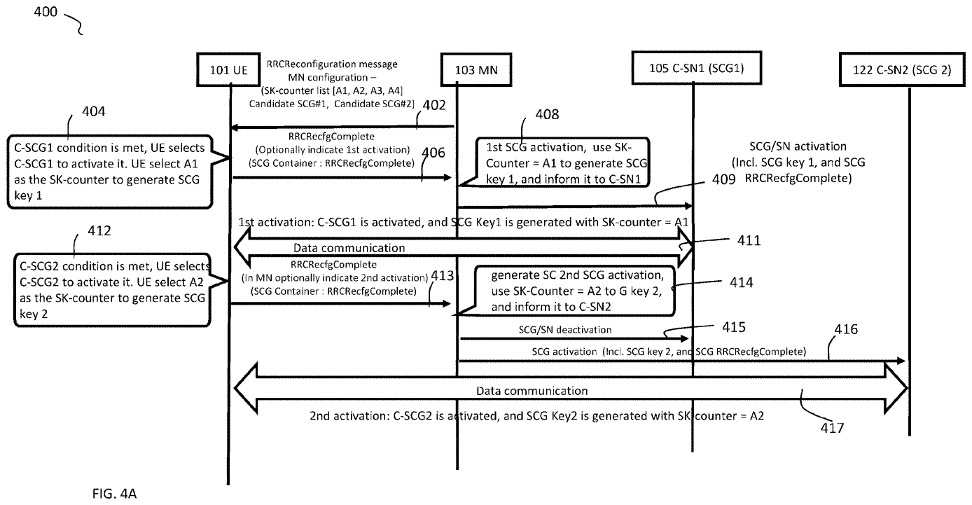

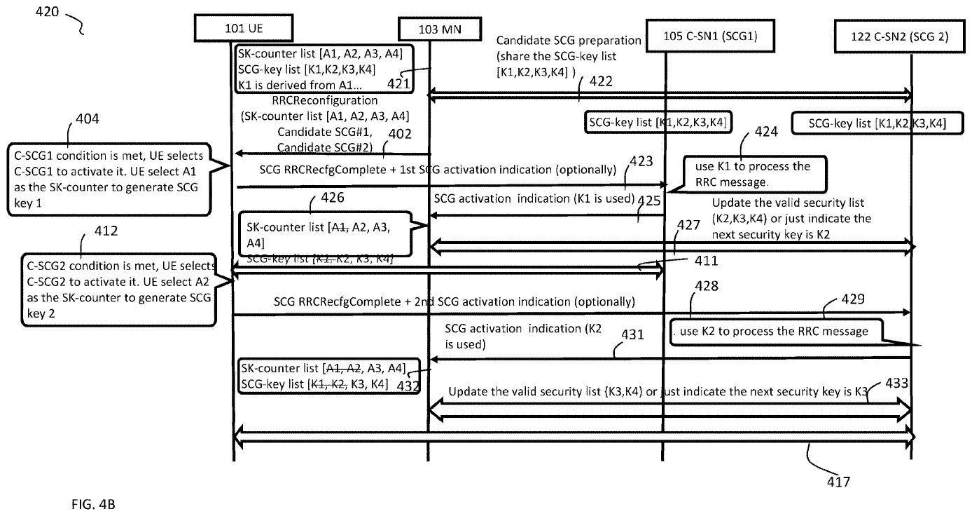

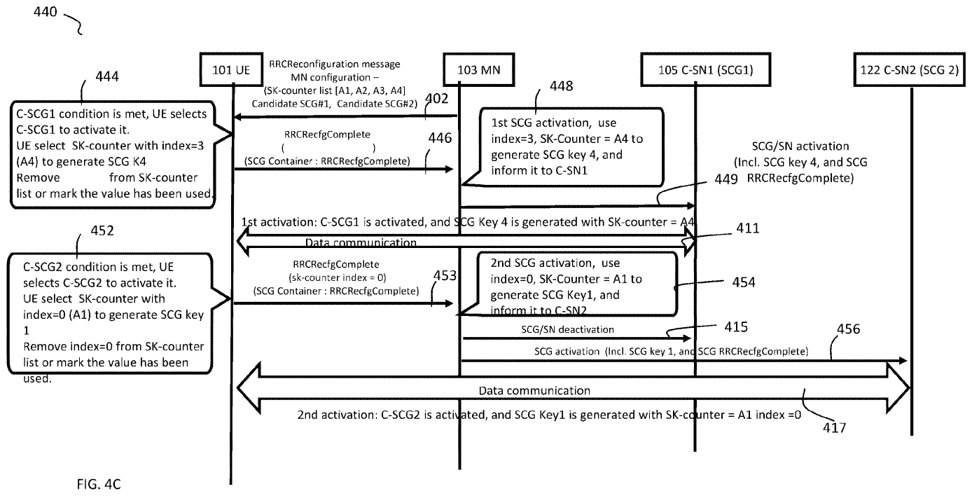

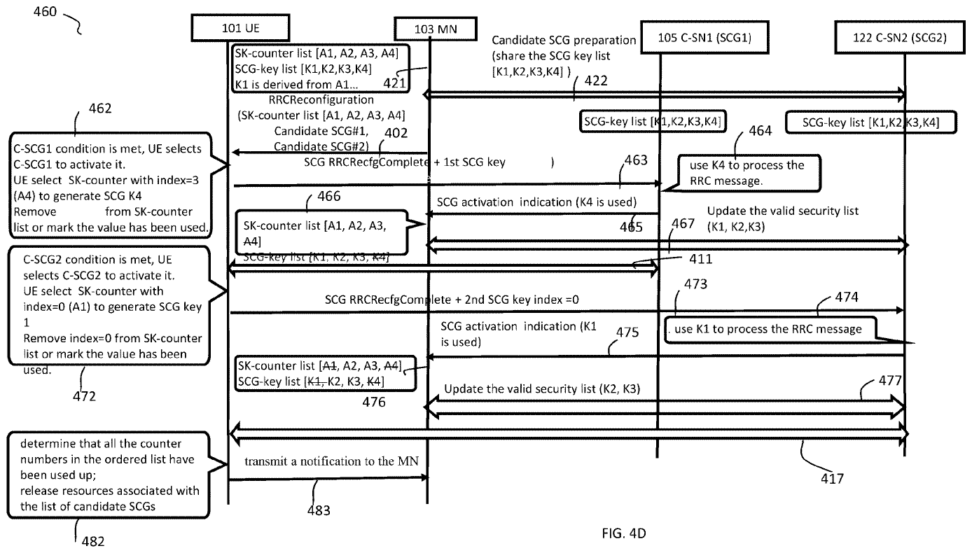

According to some aspects, to facilitate secure communication between UE 101 and the active SN, there can be various ways for the active SN to determine the same security key for the active SCG served by the active SN based on the selected counter number and a security key of the MN. More details of examples are shown in FIGS. 4A-4D.

In some embodiments, UE 101 can transmit a message to MN 103 to indicate the current value of the total number of activations, where the total number of SCG activations enables MN 103 to independently generate the security key for the active SCG served by the active SN based on the selected counter number and the security key. Afterwards, the MN can transmit the generated security key 141 for the active SCG to the active SN. In some embodiments, the message transmitted to MN 103 can include a RRC message indicating a completion of the activation of the candidate SCG 117 and the candidate SN 119, and the current value of the total number of SCG activations is included in the RRC message. In some embodiments, the message can include a medium access control (MAC) control element (CE) transmitted together with the RRC message, and the current value of the total number of SCG activations is included in the MAC CE. In some embodiments, the message includes a RRC message to indicate a completion of the activation of the candidate SCG 117 and the candidate SN 119, where the RRC message can enable MN 103 to independently determine the current value of the total number of SCG activations using an activation record of the UE locally maintained by MN 103. By default, the total number of SCG activations refers to the current value of the total number of SCG activations.

In some embodiments, UE 101 can transmit a message indicating the current value of the total number of SCG activations to the active SN serving the active SCG, where the current value of the total number of SCG activations can enable the active SN to independently select the security key 141 from a list of security keys, where the list of security keys has a one-to-one correspondence with the ordered list of counter numbers.

In some embodiments, the predetermined selection rule 143 can be a random selection rule, the counter number 115 having the index can be randomly selected from the ordered list of counter numbers. UE 101 can transmit a message indicating the index to MN 101 or the active SN serving the active SCG, where the index enables the MN or active SN to select the security key from a list of security keys. The list of security keys has a one-to-one correspondence with the ordered list of counter numbers.

According to some aspects, UE 101 can determine that all the counter numbers in the ordered list have been used up based on the activation record 131 and the total number of SCG activations 133, and further transmit a notification to MN 103 to indicate the determination that all the counter numbers in the ordered list have been used up. Afterwards, UE 101 can release resources associated with the list of candidate SCGs.

According to some aspects, the candidate SCG 117 can be selected to be activated to become the active SCG at a first time instance based on a first activation record, and a first security key is used for communication between UE 101 and the active SN. In addition, the candidate SCG 117 can be activated to become the active SCG at a second time instance based on a second activation record, and a second security key different from the first security key is used for communication between UE 101 and the active SN. Therefore, even though the same candidate SCG is selected to be the active SCG at different times, the security keys used for communication between UE 101 and the active SCG are different at different times. Hence, the security key for the active SCG, or SCG security key, is updated for selective SCG activation when the condition for the candidate SCG is met at different times. Therefore, the security of the wireless system can be increased.

FIG. 3B illustrates an example process 310 performed by a base station to update SCG security key for selective SCG activation, according to some aspects of the disclosure. Process 310 can be performed by base station 103 as shown in FIGS. 1A-1C, which can be referred to as MN 103. More details of examples are shown in FIGS. 4A-4D.

At 312, base station 103 can transmit master node configuration 113 to UE 101. In some embodiments, base station 103 can transmit master node configuration 113 to UE 101. Master node configuration 113 can include an ordered list of counter numbers, and a list of candidate SCGs of the plurality of SCGs served by a list of candidate SNs. A candidate SCG served by a candidate SN has an associated activation condition.

At 314, base station 103 can identify security key 141 for an active SCG served by an active SN after a completion of an activation of the candidate SCG 117 and the candidate SN 119 to become the active SCG served by the active SN based on a determination that the associated activation condition 118 for the candidate SCG 117 is met. Security key 141 for the active SCG is generated based on security key 145 of MN 103, activation record 131 of the list of candidate SNs including the total number of SCG activations 133 by UE 101, and counter number 115 selected from the ordered list of counter numbers based on the total number of SCG activations 133 and the predetermined selection rule 143 applicable by UE 101 and MN 103. The total number of SCG activations 133 can include the activation of candidate SCG 117 and candidate SN 119.

In some embodiments, base station 103 can identify a security key for an active SCG served by an active SN after a completion of an activation of the candidate SCG 117 and the candidate SN 119 to become the active SCG served by the active SN based on a determination that the associated activation condition 118 for the candidate SCG 117 is met. The security key 141 for the active SCG can be generated based on a security key 145 of MN 103, the activation record 133 of the list of candidate SNs including the total number of SCG activations 133, and counter number 115 selected from the ordered list of counter numbers based on the total number of SCG activations 133 and a predetermined selection rule 143 applicable by UE 101 and MN 103. The total number of SCG activations 133 includes the activation of the candidate SCG 117 and the candidate SN 119.

In some embodiments, to identify the security key 141 for the active SCG, base station 103 can receive a completion message from UE 101. The completion message can indicate the completion of the activation of the candidate SCG 117 and the candidate SN 119 to become the active SCG served by the active SN. Base station 103 can further receive a security key indication from UE 101 about the security key 141 for the active SCG served by the active SN.

In some embodiments, the security key indication can include an indication of the total number of SCG activations 133 to identify the security key. Base station 103 can generate the security key 141 for the active SCG served by the active SN based on the security key 145 of the MN, and the counter number 115 selected by the predetermined selection rule 143 based on the total number of SCG activations 133. Afterwards, base station 103 can transmit the security key 141 for the active SCG to the active SN.

In some embodiments, the completion message includes a RRC message indicating the completion of the activation of the candidate SCG and the candidate SN, and the total number of SCG activations 133 is included in the RRC message. In some embodiments, the completion message includes a MAC CE transmitted together with the RRC message, and the total number of SCG activations 133 is included in the MAC CE.

In some embodiments, the completion message includes a RRC message to indicate the completion of the activation of the candidate SCG 117 and the candidate SN 119, and base station 103 can determine the total number of SCG activations 133 using an activation record of UE 101 maintained by MN 103.

In some embodiments, the security key indication can include an index of the counter number 115 within the ordered list, the predetermined selection rule 143 is a random selection rule, and the counter number 115 having the index is randomly selected from the ordered list of counter numbers based on the random selection rule.

In some embodiments, base station 103 can generate a list of security keys, which has a one-to-one correspondence with the ordered list of counter numbers, and distribute the list of security keys to the list of candidate SNs of the list of candidate SCGs. To identify the security key for the active SCG, base station 103 can receive the security key from the active SN, where the security key is identified by the SN based on the list of security keys and an indication of the counter number selected from the ordered list of counter numbers.

In some embodiments, the predetermined selection rule 143 can be a random selection rule, and the indication of the counter number includes an index of the counter number within the ordered list. In some embodiments, the counter number having the index can be randomly selected from the ordered list of counter numbers based on the random selection rule.

FIGS. 4A-4D illustrate example processes for SCG security key update for selective SCG activation, according to some aspects of the disclosure. Processes shown in FIGS. 4A-4D are examples of process 300 performed by UE 101 and process 310 performed by base station 103, and other base stations such as base station 105 within SCG 153, which can be SCG #1,and base station 122 within SCG 155, which can be SCG #2.

Process 400 shown in FIG. 4A performs operations related to SCG security key update for selective SCG activation, according to some aspects of the disclosure.

At 402, MN 103 can send a RRC message to UE 101, where the RRC message can be a RRC Reconfiguration message. The message can include MN configuration 113. MN configuration 113 includes an ordered list of counter numbers, shown as sk_counter list including [A1, A2, A3, A4], where A1, A2, A3, and A4 each is a counter number or a sk_counter. In embodiments, A1, A2, A3, and A4 are integer numbers. MN configuration 113 can further include a list of candidate SCGs, including candidate SCG #1 (C-SCG1), candidate SCG #2 (C-SCG2), and more. Other component of MN configuration 113, such as a list of candidate SNs and an associated activation condition for each candidate SCG, are not shown.

At 404, UE 101 can perform operations described in process 300. In detail, UE 101 can detect the channel conditions between UE 101 and base station 103, base station 105, and other base stations, and determine that the activation condition for a candidate SCG, such as C-SCG1 condition is met. There are multiple candidate SCGs included in MN configuration 113. UE 101 may monitor the conditions for all such candidate SCGs, and select the SCG having its activation condition met. UE 101 may maintain the activation record 131 including the total number of SCG activations 133 by the UE before selecting the candidate SCG to be activated. Initially, the total number of SCG activations 133 is 0 since there is no SCG has been activated yet. Hence, UE 101 performs selective activation of SCGs. In some embodiments, UE 101 selects C-SCG1 to activate it, and further updates the total number of SCG activations 133 to become 1. UE 101 applies the predetermined selection rule 143 to select a counter number. In some embodiments, the predetermined selection rule 143 selects the counter number according to the total number of activations 133. Hence, UE 101 select A1 as the sk_counter to generate SCG key 1, since the activation of C-SCG1 is the first activation. SCG key 1 can be used for secure communication between UE 101 and SN 105 of C-SCG1.

At 406, UE 101 can transmit a message, such as a RRC message that can be RRCRecfgComplete to indicate the completion of the activation of the candidate SCG, e.g., C-SCG1, and the candidate SN. The RRC message can be viewed as a SCG container, and can optionally include the total number of SCG activations. The total number of SCG activations included in the message considers the activation of the C-SCG1. In the current example, the activation of C-SCG1 is the first activation.

At 408, MN 103 can use the total number of SCG activations to select the first counter number, sk_counter A1, to generate SCG key 1.

At 409, MN 103 can send the security key, SCG key 1, to the SN of C-SCG1, which is shown as C-SN1, or base station 105. MN 103 can transmit a RRC message, such as a RRCRecfgComplete message, to SN 105 to indicate the security SCG key 1.

At 411, a secure communication channel between UE 101 and SN 105 is established. Data communication can be performed between UE 101 and SN 105. The activation of C-SCG1 is the first activation as shown. Accordingly, C-SCG1 is activated, and SCG Key1 is generated with sk_counter=A1.

At 412, UE 101 can detect the channel conditions between UE 101 and base station 103, base station 105, and other base stations, and determine that the activation condition for a candidate SCG, such as C-SCG2 condition is met. UE 101 selects C-SCG2 to activate it. UE 101 further maintains activation record 131, and the total number of SCG activations 133. In this example, the total number of SCG activations 133 shows the current activation of C-SCG2 is the second activation. Hence, the total number of SCG activations 133 is 2. Accordingly, UE 101 can select the second counter number, which is the second sk_counter A2 to generate SCG key 2.

At 413, UE 101 can transmit a message, such as a RRC message that can be RRCRecfgComplete to indicate the completion of the activation of the candidate SCG, e.g., C-SCG2, and the candidate SN. The RRC message can optionally include the total number of SCG activations. The total number of SCG activations included in the message has included the activation of the C-SCG2. In the current example, the activation of C-SCG2 is the second activation.

At 414, MN 103 can use the total number of SCG activations, which is 2, to select the second counter number, sk_counter A2, to generate SCG key 2. Accordingly, by merely transmitting the total number of SCG activations, MN 103 can determine the counter number, sk_counter A2, used to generate SCG key 2, and further generate SCG key 2 without being transmitted from UE 101. Therefore, security can be improved.

At 415, MN 103 can further deactivate the previous SCG, C-SCG1.

At 416, MN 103 can send the security key, SCG key 2, to the SN of C-SCG2, which is shown as C-SN2, or base station 122. MN 103 can transmit a RRC message, such as a RRCRecfgComplete message, to SN 122 to indicate the security key SCG key 2.

At 417, a secure communication channel between UE 101 and SN 122 is established. Data communication can be performed between UE 101 and SN 122. The activation of C-SCG2 is the second activation as shown. Accordingly, C-SCG2 is activated, and SCG Key 2 is generated with sk_counter=A2.

Process 420 shown in FIG. 4B performs operations related to SCG security key update for selective SCG activation, according to some aspects of the disclosure.

At 421, MN 103 generate a list of security keys, [K1, K2, K3, K4 . . . ], which has a one-to-one correspondence with the ordered list of counter numbers, e.g., sk_counter list [A1, A2, A3, A4 . . . ]. Accordingly, security K1 is derived from sk_counter A1, based on a security algorithm and a security key of MN 101. The sk_counter list [A1, A2, A3, A4 . . . ] and the list of security keys, [K1, K2, K3, K4 . . . ] can be allocated to any SCGs, and hence are shared by the SCGs serving UE 101.

At 422, MN 103 can distribute the list of security keys, [K1, K2, K3, K4 . . . ], to the list of candidate SNs of the list of candidate SCGs, such as SCG 153, SCG 155. The list of security keys, [K1, K2, K3, K4 . . . ] are further saved by SN 105 and SN 122.

At 402, MN 103 can send a RRC message to UE 101, where the RRC message can be a RRC Reconfiguration message. The message can include MN configuration 113. MN configuration 113 includes an ordered list of counter numbers, shown as sk_counter list including [A1, A2, A3, A4], where A1, A2, A3, and A4 each is a counter number, e.g., a sk_counter. MN configuration 113 can further include a list of candidate SCGs, including candidate SCG #1 (C-SCG1), candidate SCG #2 (C-SCG2), and more.

At 404, UE 101 can detect the channel conditions between UE 101 and base station 103, base station 105, and other base stations, and determine that the activation condition for a candidate SCG, such as C-SCG1 condition is met. UE 101 select A1 as the sk_counter to generate SCG key 1.

At 423, UE 101 can transmit a message to SN 105, such as a RRC message that can be RRCRecfgComplete to indicate the completion of the activation of the candidate SCG, e.g., C-SCG1, and the candidate SN. The RRC message can be viewed as a SCG container, and can optionally include the total number of SCG activations. The total number of SCG activations included in the message considers the activation of the C-SCG1. In the current example, the activation of C-SCG1 is the first activation.

At 424, SN 105 can use the total number of SCG activations to select the first security K1 from the list of security keys, and further use the first security K1 to process the RRC message.

At 425, SN 105 can transmit an indication to MN 103 that the first security key K1 is used for the SCG activation of SCG1.

A 426, MN 103 can update the list of security keys [K1, K2, K3, K4 . . . ] and the list of counter numbers [A1, A2, A3, A4] to indicate that the first security key K1 and its corresponding counter number A1 has been used. MN 103 can further update the list of security keys [K1, K2, K3, K4 . . . ] to remove K1 to obtain an updated security key list [K1, K2, K3, K4 . . . ] or [K2, K3, K4 . . . ]. Similar update can be done for the list of counter numbers [A1, A2, A3, A4] to become [A1, A2, A3, A4 . . . ] or [A2, A3, A4 . . . ].

At 427, MN 103 can distribute the updated valid security list (K2,K3,K4) to the SCGs including SCG 153 and SCG 155. The updated valid security list (K2,K3,K4) can be saved by SN 105 and SN 122 respectively. There can be other ways by MN 103 to indicate to remove the first key from the list of security keys previously saved by 105 and SN 122.

At 411, a secure communication channel between UE 101 and SN 105 is established. Data communication can be performed between UE 101 and SN 105. The activation of C-SCG1 is the first activation as shown. Accordingly, C-SCG1 is activated, and SCG Key1 is generated with sk_counter=A1.

At 412, UE 101 can detect the channel conditions between UE 101 and base station 103, base station 105, and other base stations, and determine that the activation condition for a candidate SCG, such as C-SCG2 condition is met. UE 101 selects C-SCG2 to activate it. UE 101 further maintain activation record 133, and the total number of SCG activations 133. In this example, the total number of SCG activations 133 shows the current activation of C-SCG2 is the second activation. Hence, the total number of SCG activations 133 is 2. Accordingly, UE 101 can select the second counter number, which is the second sk_counter A2 to generate SCG key 2.

At 428, UE 101 can transmit a message to SN 105, such as a RRC message that can be RRCRecfgComplete to indicate the completion of the activation of the candidate SCG, e.g., C-SCG2, and the candidate SN. The RRC message can be viewed as a SCG container, and can optionally include the total number of SCG activations. The total number of SCG activations included in the message has included the activation of the C-SCG2. In the current example, the activation of C-SCG2 is the second activation.

At 429, SN 105 can use the total number of SCG activations to select the second security K2 from the list of security keys, and further use the second security K2 to process the RRC message.

At 431, SN 105 can transmit an indication to MN 103 that the second security key K2 is used for the SCG activation of SCG2.

A 432, MN 103 can update the list of security keys [K2, K3, K4 . . . ] and the list of counter numbers [A2, A3, A4] to indicate that the first security key K2 and its corresponding counter number A2 has been used. MN 103 can further update the list of security keys [K2, K3, K4 . . . ] to remove K2 to obtain an updated security key list [K3, K4 . . . ] or [K3, K4 . . . ]. Similar update can be done for the list of counter numbers [A1, A2, A3, A4] to become [A3, A4 . . . ] or [A3, A4 . . . ].

At 433, MN 103 can distribute the updated valid security list (K3,K4) to the SCGs including SCG 153 and SCG 155. The updated valid security list (K3,K4) can be saved by SN 105 and SN 122 respectively. There can be other ways by MN 103 to indicate to remove the second key from the list of security keys previously saved by 105 and SN 122.

At 417, a secure communication channel between UE 101 and SN 122 is established. Data communication can be performed between UE 101 and SN 122. The activation of C-SCG2 is the second activation as shown. Accordingly, C-SCG2 is activated, and SCG Key2 is generated with sk_counter=A2.

Process 440 shown in FIG. 4C performs operations related to SCG security key update for selective SCG activation, according to some aspects of the disclosure.

At 402, MN 103 can send a RRC message to UE 101, where the RRC message can be a RRC Reconfiguration message. The message can include MN configuration 113. MN configuration 113 includes an ordered list of counter numbers, shown as sk_counter list including [A1, A2, A3, A4, . . . ], where A1, A2, A3, and A4 each is a counter number or a sk_counter. MN configuration 113 can further include a list of candidate SCGs, including candidate SCG #1 (C-SCG1), candidate SCG #2 (C-SCG2), and more. Other component of MN configuration 113, such as a list of candidate SNs, associated activation condition for each candidate SCG, are not shown.

At 444, UE 101 can detect the channel conditions between UE 101 and base station 103, base station 105, and other base stations, and determine that the activation condition for a candidate SCG, such as C-SCG1 condition is met. In some embodiments, UE 101 selects C-SCG1 to activate it. Operations performed here are different from operations performed at 404 of FIG. 4A. As shown above in FIG. 4A, at 404 in FIG. 4A, UE 101 select A1 as the sk_counter to generate SCG key 1, corresponding to the first activation of the SCG. In some embodiments, at 444, the predetermined selection rule 143 is a random selection rule, the counter number having the index is randomly selected from the ordered list of counter numbers. Accordingly, UE 101 can randomly select a counter number, e.g., A4, which can be used to generate a security key, SCG key K4 having an index 3, where the index starts from position 0. Security key, SCG key K4 can be used for secure communication between UE 101 and SN 105 of C-SCG1.

At 446, UE 101 can transmit a message, such as a RRC message that can be RRCRecfgComplete to indicate the completion of the activation of the candidate SCG, e.g., C-SCG1. The message can include the index 3, not the total number of SCG activations, to be transmitted to MN 103. The total number of SCG activations is not included in the message because the selection of K4 with index 3 is randomly selected and cannot be determined based on the total number of SCG activations alone.

At 448, MN 103 can use the received index 3 to select the counter number, sk_counter A4, to generate SCG key 4.

At 449, MN 103 can inform the security key, SCG key 4, to SN 105 of C-SCG1. MN 103 can transmit a RRC message, such as a RRCRecfgComplete message, to SN 105 to inform the security key SCG key 4.

At 411, a secure communication channel between UE 101 and SN 105 is established. Data communication can be performed between UE 101 and SN 105. The activation of C-SCG1 is the first activation as shown. Accordingly, C-SCG1 is activated, and SCG Key 4 is generated with sk_counter=A4.

At 452, UE 101 can detect the channel conditions between UE 101 and base station 103, base station 105, and other base stations, and determine that the activation condition for a candidate SCG, such as C-SCG2 condition is met. UE 101 selects C-SCG2 to activate it. UE 101 further maintain activation record 133, and the total number of SCG activations 133. In this example, the total number of SCG activations 133 shows the current activation of C-SCG2 is the second activation. Hence, the total number of SCG activations 133 is 2. However, since the predetermined selection rule 143 is a random selection rule, as shown in operation 444, UE 101 can randomly select a counter number, which is the sk_counter A1 to generate SCG key 1 with an index 0.

At 453, UE 101 can transmit a message, such as a RRC message that can be RRCRecfgComplete to indicate the completion of the activation of the candidate SCG, e.g., C-SCG2. The RRC message can optionally include the index 0.

At 454, MN 103 can use the index 0 received from UE 101 to select the first counter number, sk_counter A1, to generate SCG key 1.

At 415, MN 103 can further deactivate the previous SCG, C-SCG1.

At 456, MN 103 can inform the security key, SCG key 1, to the SN of C-SCG2, which is shown as C-SN2, or base station 122. MN 103 can transmit a RRC message, such as a RRCRecfgComplete message, to SN 122 to inform the security key SCG key 1.

At 417, a secure communication channel between UE 101 and SN 122 is established. Data communication can be performed between UE 101 and SN 122. The activation of C-SCG2 is the second activation as shown. Accordingly, C-SCG2 is activated, and SCG Key 1 is generated with sk_counter=A1.

Process 460 shown in FIG. 4D performs operations related to SCG security key update for selective SCG activation, according to some aspects of the disclosure.

At 421, MN 103 generate a list of security keys, [K1, K2, K3, K4 . . . ], which has a one-to-one correspondence with the ordered list of counter numbers, e.g., sk_counter list [A1, A2, A3, A4 . . . ]. Accordingly, security K1 is derived from sk_counter A1, based on a security algorithm and a security key of MN 101. The sk_counter list [A1, A2, A3, A4 . . . ] and the list of security keys, [K1, K2, K3, K4 . . . ] can be allocated to any SCGs, and hence are shared by the SCGs serving UE 101.

At 422, MN 103 can distribute the list of security keys, [K1, K2, K3, K4 . . . ], to the list of candidate SNs of the list of candidate SCGs, such as SCG 153, SCG 155. The list of security keys, [K1, K2, K3, K4 . . . ] are further saved by SN 105 and SN 122.

At 402, MN 103 can send a RRC message to UE 101, where the RRC message can be a RRC Reconfiguration message. The message can include MN configuration 113. MN configuration 113 includes an ordered list of counter numbers, shown as sk_counter list including [A1, A2, A3, A4], where A1, A2, A3, and A4 each is a counter number, e.g., a sk_counter. MN configuration 113 can further include a list of candidate SCGs, including candidate SCG #1 (C-SCG1), candidate SCG #2 (C-SCG2), and more.

At 462, UE 101 can detect the channel conditions between UE 101 and base station 103, base station 105, and other base stations, and determine that the activation condition for a candidate SCG, such as C-SCG1 condition is met. UE 101 can randomly select A4 as the sk_counter to generate SCG key 4 with an index 3, and further mark A4 and K4 are used.

At 463, UE 101 can transmit a message to SN 105, such as a RRC message that can be RRCRecfgComplete to indicate the completion of the activation of the candidate SCG, e.g., C-SCG1. The RRC message can include the index=3.

At 464, SN 105 can use the index=3 to select the security key K4 from the list of security keys, and further use the security key K4 to process the RRC message.

At 465, SN 105 can transmit an indication to MN 103 that the security key K4 is used for the SCG activation of SCG1.

A 466, MN 103 can update the list of security keys [K1, K2, K3, K4 . . . ] and the list of counter numbers [A1, A2, A3, A4] to indicate that the security key K4 and its corresponding counter number A4 has been used. MN 103 can further update the list of security keys [K1, K2, K3, K4 . . . ] to remove K4 to obtain an updated security key list [K1, K2, K3, . . . ] or [K1, K2, K3 . . . ]. Similar update can be done for the list of counter numbers [A1, A2, A3, A4] to become [A1, A2, A3, . . . ] or [A1, A2, A3 . . . ].

At 467, MN 103 can distribute the updated valid security list [K1, K2, K3 . . . ] to the SCGs including SCG1 and SCG2. The updated valid security list [K1, K2, K3 . . . ] can be saved by SN 105 and SN 122 respectively. There can be other ways by MN 103 to indicate to remove K4 from the list of security keys previously saved by 105 and SN 122.

At 411, a secure communication channel between UE 101 and SN 105 is established. Data communication can be performed between UE 101 and SN 105. The activation of C-SCG1 is the first activation as shown. Accordingly, C-SCG1 is activated, and SCG Key1 is generated with sk_counter=A1.

At 472, UE 101 can detect the channel conditions between UE 101 and base station 103, base station 105, and other base stations, and determine that the activation condition for a candidate SCG, such as C-SCG2 condition is met. UE 101 selects C-SCG2 to activate it. UE 101 further maintain activation record 133, and the total number of SCG activations 133. In this example, the total number of SCG activations 133 shows the current activation of C-SCG2 is the second activation. Hence, the total number of SCG activations 133 is 2. However, since the predetermined selection rule 143 is a random selection rule, as shown in operation 452, UE 101 can randomly select a counter number, which is the sk_counter A1 to generate SCG key 1 with an index 0.

At 473, UE 101 can transmit a message to SN 105, such as a RRC message that can be RRCRecfgComplete to indicate the completion of the activation of the candidate SCG, e.g., C-SCG1, and the candidate SN. The RRC message can include index 0.

At 474, SN 105 can use index 0 to select the first security K1 from the list of security keys, and further use the first security K1 to process the RRC message.

At 475, SN 105 can transmit an indication to MN 103 that the first security key K1 is used for the SCG activation of SCG1.

A 476, MN 103 can update the list of security keys [K1, K2, K3, . . . ] and the list of counter numbers [A1, A2, A3,] to indicate that the first security key K1 and its corresponding counter number A1 has been used. MN 103 can further update the list of security keys [K1, K2, K3, . . . ] to remove K1 to obtain an updated security key list [K2, K3, . . . ] or [K2, K3, . . . ]. Similar update can be done for the list of counter numbers [A1, A2, A3,] to become [A2, A3, . . . ] or [A2, A3, . . . ].

At 477, MN 103 can distribute the updated valid security list (K2,K3) to the SCGs including SCG 153 and SCG 155. The updated valid security list (K2,K3) can be saved by SN 105 and SN 122 respectively. There can be other ways by MN 103 to indicate to remove K1 from the list of security keys previously saved by 105 and SN 122.

At 417, a secure communication channel between UE 101 and SN 122 is established. Data communication can be performed between UE 101 and SN 122. The activation of C-SCG2 is the second activation as shown. Accordingly, C-SCG2 is activated, and SCG Key2 is generated with sk_counter=A2.

At 482, UE 101 can determine that all the counter numbers in the ordered list have been used up based on the activation record and the total number of SCG activations. UE 101 can further release resources associated with the list of candidate SCGs.

At 483, UE 101 can transmit a notification to the MN to indicate the determination that all the counter numbers in the ordered list have been used up.

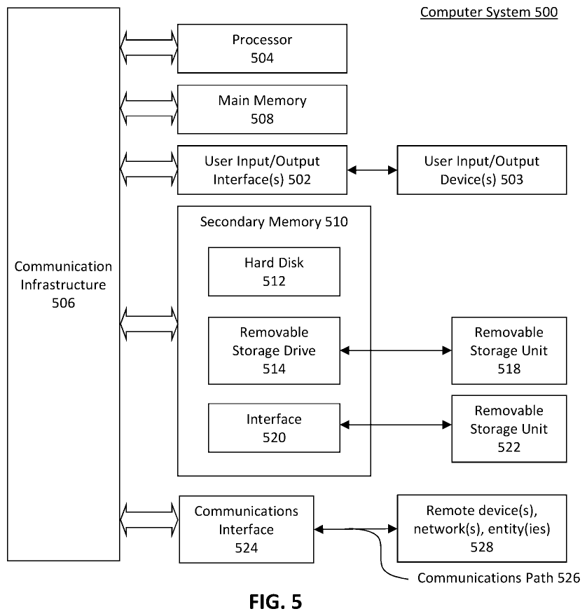

Various aspects can be implemented, for example, using one or more computer systems, such as computer system 500 shown in FIG. 5. Computer system 500 can be any computer capable of performing the functions described herein such as UE 101 or base station 103 as shown in FIG. 1A, FIG. 1B, and FIG. 2, for operations described for UE 101, base station 103, process 300 and process 310 as shown in FIGS. 3A-3B, or process 400, process 420, process 440, or process 460 as shown in FIGS. 4A-4D. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., UE 101 or base station 103 as shown in FIG. 1A, FIG. 1B, and FIG. 2, for operations described for UE 101, base station 103, process 300 and process 310 as shown in FIGS. 3A-3B, or process 400, process 420, process 440, or process 460 as shown in FIGS. 4A-4D.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

1. A user equipment (UE), comprising:
a transceiver configured to enable communication in a wireless system, wherein the wireless system includes a master node (MN) of a master cell groups (MCG) and a plurality of secondary nodes (SNs) of a plurality of second cell groups (SCGs); and
a processor communicatively coupled to the transceiver and configured to:
receive a master node configuration provided from the MN, wherein the master node configuration includes an ordered list of counter numbers, and a list of candidate SCGs configuration of the plurality of SCGs served by respective candidate SNs, wherein a candidate SCG served by a candidate SN has an associated activation condition;
maintain an activation record indicating a total number of SCG activations by the UE, wherein the total number of SCG activations has an initial value;
select the candidate SCG and the candidate SN to be activated to become an active SCG based on a determination that the associated activation condition for the candidate SCG is met;
update, based on the activation of the candidate SCG, the total number of SCG activations to increase the initial value by 1 to calculate a current value of the total number of SCG activations;
select a counter number from the ordered list of counter numbers, wherein the counter number has an index within the ordered list, and the index is determined based on the current value of the total number of SCG activations and a predetermined selection rule applicable by the UE and the MN; and
generate a security key for the active SCG served by the active SN based on the selected counter number and a security key of the MN.

2. The UE of claim 1, wherein the processor is further configured to transmit a message to the MN to indicate the current value of the total number of SCG activations, wherein the total number of SCG activation enables the MN to independently generate the security key for the active SCG served by the active SN based on the selected counter number and the security key of the MN.

3. The UE of claim 2, wherein the message includes Radio Resource Control (RRC) message indicating a completion of the activation of the candidate SCG and the candidate SN, and the current value of the total number of SCG activations is included in the RRC message; or
the message includes a medium access control (MAC) control element (CE) transmitted together with the RRC message, and the current value of the total number of SCG activations is included in the MAC CE.

4. The UE of claim 2, wherein the message includes a Radio Resource Control (RRC) message to indicate a completion of the activation of the candidate SCG and the candidate SN, wherein the RRC message enables the MN to independently determine the current value of the total number of SCG activations using an activation record of the UE locally maintained by the MN.

5. The UE of claim 1, wherein the processor is further configured to transmit a message indicating the current value of the total number of SCG activations to the active SN serving the active SCG, wherein the current value of the total number of SCG activations enables the active SN to independently select the security key from a list of security keys wherein the list of security keys has a one-to-one correspondence with the ordered list of counter numbers.

6. The UE of claim 1, wherein the predetermined selection rule is a random selection rule, the counter number having the index is randomly selected from the ordered list of counter numbers, the processor is further configured to transmit a message indicating the index to the MN or the active SN serving the active SCG, wherein the index enables the MN or active SN to select the security key from a list of security keys, wherein the list of security keys has a one-to-one correspondence with the ordered list of counter numbers.

7. The UE of claim 1, wherein the processor is further configured to communicate data between the UE and the active SN within the active SCG, wherein the data is protected by the security key for communication between the UE and the active SN.

8. The UE of claim 1, wherein the ordered list of counter numbers comprises a block of consecutive numbers in a range defined by a starting number and a maximum number indicated by the master node configuration.

9. The UE of claim 1, wherein the candidate SCG is selected to be activated to become the active SCG at a first time instance based on a first activation record, and a first security key is used for communication between the UE and the active SN, and
the candidate SCG is activated to become the active SCG at a second time instance based on a second activation record, and a second security key different from the first security key is used for communication between the UE and the active SN.

10. The UE of claim 1, wherein the processor is further configured to:
determine that all the counter numbers in the ordered list have been used up based on the activation record and the current value of the total number of SCG activations;
transmit a notification to the MN to indicate the determination that all the counter numbers in the ordered list have been used up; and
optionally release resources associated with the list of candidate SCGs.

11. A base station, comprising:
a transceiver configured to enable communication in a wireless system, wherein the wireless system includes the base station as a master node (MN) of a Master Cell Group (MCG), a user equipment (UE), and a plurality of secondary nodes (SNs) of a plurality of second cell groups (SCGs); and
a processor communicatively coupled to the transceiver and configured to:
transmit a master node configuration to the UE, wherein the master node configuration includes an ordered list of counter numbers, and a list of candidate SCGs configuration of the plurality of SCGs served by respective candidate SNs, wherein a candidate SCG served by a candidate SN has an associated activation condition; and
identify a security key for an active SCG served by an active SN, wherein the security key for the active SCG is generated based on a security key of the MN, an activation record of the list of candidate SNs including a total number of SCG activations by the UE, and a counter number selected from the ordered list of counter numbers, wherein the counter number is based on the total number of SCG activations and a predetermined selection rule applicable, wherein the total number of SCG activations includes an activation of the candidate SCG and the candidate SN to become the active SCG and the active SN.

12. The base station of claim 11, wherein to identify the security key for the active SCG, the processor is configured to:
receive a completion message from the UE, wherein the completion message indicates the completion of the activation of the candidate SCG and the candidate SN to become the active SCG served by the active SN; and
receive, from the UE, a security key indication associated with the security key for the active SCG served by the active SN.

13. The base station of claim 12, wherein the security key indication includes an indication of the total number of SCG activations, wherein to identify the security key, the processor is further configured to:
generate the security key for the active SCG served by the active SN based on the security key of the MN and the counter number selected by the predetermined selection rule based on the total number of SCG activations; and
transmit the security key for the active SCG to the active SN.

14. The base station of claim 13, wherein the completion message includes a Radio Resource Control (RRC) message indicating the completion of the activation of the candidate SCG and the candidate SN, and the total number of SCG activations is included in the RRC message; or
the completion message includes a medium access control (MAC) control element (CE) transmitted together with the RRC message, and the total number of SCG activations is included in the MAC CE.

15. The base station of claim 13, wherein the completion message includes a Radio Resource Control (RRC) message to indicate the completion of the activation of the candidate SCG and the candidate SN, and the processor is further configured to determine the total number of SCG activations using an activation record of the UE maintained by the MN.

16. The base station of claim 12, wherein the security key indication includes an index of the counter number within the ordered list, the predetermined selection rule is a random selection rule, and wherein the counter number having the index is randomly selected from the ordered list of counter numbers based on the random selection rule.

17. The base station of claim 11, wherein the processor is further configured to:
generate a list of security keys, wherein the list of security keys has a one-to-one correspondence with the ordered list of counter numbers; and
distribute the list of security keys to the list of candidate SNs of the list of candidate SCGs.

18. The base station of claim 16, wherein to identify the security key for the active SCG, the processor is configured to:
receive the security key from the active SN, wherein the security key is identified by the SN based on the list of security keys and an indication of the counter number selected from the ordered list of counter numbers.

19. The base station of claim 18, wherein the predetermined selection rule is a random selection rule, and the indication of the counter number includes an index of the counter number within the ordered list, wherein the counter number having the index is randomly selected from the ordered list of counter numbers based on the random selection rule.

20. A method for communication, comprising:
receiving a master node configuration from a master node (MN) of a wireless system, wherein the wireless system includes the MN of a master cell groups (MCG) and a plurality of secondary nodes (SNs) of a plurality of second cell groups (SCGs), the master node configuration includes an ordered list of counter numbers, a list of candidate SCG configurations of the plurality of SCGs served by a list of candidate SNs, wherein a candidate SCG served by a candidate SN has an associated activation condition, wherein a counter number of the ordered list of counter numbers is able to be allocated to any candidate SCG of the list of candidate SCGs;
maintaining an activation record including a total number of SCG activations by the UE before selecting the candidate SCG to be activated, wherein the total number of SCG activations has an initial value;
selecting the candidate SCG and the candidate SN to be activated to become an active SCG served by an active SN based on a determination that the associated activation condition for the candidate SCG is met;
updating the total number of SCG activations to increase the initial value by 1 to be a current value of the total number of SCG activations, based on the activation of the candidate SCG;
selecting a counter number from the ordered list of counter numbers, wherein the counter number has an index within the ordered list, and the index is determined based on the current value of the total number of SCG activations and a predetermined selection rule applicable by the UE and the MN; and
generating a security key for the active SCG served by the active SN based on the selected counter number and a security key of the MN.
